(19) United States
(12) Patent Application Publication
(10) Pub. No.: US 2022/0164808 A1
(43) Pub. Date: May 26, 2022

(54) MACHINE-LEARNING MODEL FOR PREDICTING METRICS ASSOCIATED WITH TRANSACTIONS

(71) Applicant: Advance Local Media LLC d/b/a ZeroSum, New York, NY (US)

(72) Inventors: Matthew D. Sharp, Grand Rapids, MI (US); Nicholas W. Dionne, Grand Rapids, MI (US); William J. Christenson, II, Branson, MO (US); Andrew M. Zack, Grand Rapids, MI (US)

(21) Appl. No.: 17/535,183

(22) Filed: Nov. 24, 2021

Related U.S. Application Data
(60) Provisional application No. 63/117,843, filed on Nov. 24, 2020.

(51) Int. Cl. G06Q 30/02; G06N 20/00; G06Q 30/06

(52) U.S. Cl. CPC G06Q 30/0201; G06Q 30/0641; G06N 20/00

(57) ABSTRACT

A first outcome variable to be predicted by a machine-learning model (MLM) is determined. The first outcome variable is associated with a product. Using product information that comprises values for each of a plurality of different input variables, a plurality of MLMs are trained to predict the first outcome variable, each MLM utilizing a different set of input variables of the plurality of different input variables. Using historical data that identifies historical values for the first outcome variable, each MLM is tested to determine an accuracy for each MLM. A first MLM is identified based on the testing.

### RELATED APPLICATION

This application claims the benefit of U.S. Provisional Application No. 63/117,843, filed on Nov. 24, 2020, entitled “MACHINE-LEARNED MODEL FOR PREDICTING PURCHASES,” the disclosure of which is hereby incorporated herein by reference in its entirety.

### BACKGROUND

It can be important, at an instant in time, to determine whether it is likely a future goal will be met or not. Knowing that a future goal is not likely to be met provides an opportunity to alter behavior and increase a likelihood that the future goal is met.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of an environment illustrating the collection and modification of certain data suitable for training machine-learning models (MLMs) in accordance with the embodiments disclosed herein;

FIGS. 2 and 3 are flowcharts of a method for generating data suitable for training an MLM according to one embodiment;

FIG. 4 is a block diagram illustrating a training and selection process for training and selecting an MLM according to one embodiment;

FIGS. 5A-5B illustrate a flowchart of a method for training an MLM according to one embodiment;

FIG. 6 is a flowchart of a method for training an MLM for predicting metrics associated with transactions according to one embodiment;

FIG. 7 is a block diagram illustrating a use of the MLMs trained in accordance with the embodiments disclosed herein;

FIGS. 8-12 illustrate examples of user interface imagery that may be presented to a user according to one embodiment; and

FIG. 13 is a block diagram of a computing system suitable for implementing embodiments disclosed herein.

### SUMMARY

In one embodiment a method is provided. The method includes determining, by a computer system comprising one or more processor devices, a first outcome variable to be predicted by a machine-learning model (MLM), the first outcome variable associated with a product. The method further includes training, using product information that comprises values for each of a plurality of different input variables, a plurality of MLMs to predict the first outcome variable, each MLM utilizing a different set of input variables of the plurality of different input variables. The method further includes testing, using historical data that identifies historical values for the outcome variable, each MLM to determine an accuracy for each MLM. The method further includes identifying, for use in making predictions, a first MLM based on the testing.

In another embodiment a computing system is provided. The computing system includes a memory and one or more processor devices coupled to the memory. The one or more processor devices are to determine a first outcome variable to be predicted by a machine-learning model (MLM), the first outcome variable associated with a product. The one or more processor devices are further to train, using product information that comprises values for each of a plurality of different input variables, a plurality of MLMs to predict the first outcome variable, each MLM utilizing a different set of input variables of the plurality of different input variables. The one or more processor devices are further to test, using historical data that identifies historical values for the first outcome variable, each MLM to determine an accuracy for each MLM. The one or more processor devices are further to identify, for use in making predictions, a first MLM based on the testing.

In another embodiment a non-transitory computer-readable storage medium is provided. The non-transitory computer-readable storage medium includes executable instructions to cause a processor device to determine a first outcome variable to be predicted by a machine-learning model (MLM), the first outcome variable associated with a product. The instructions further cause the processor device to train, using product information that comprises values for each of a plurality of different input variables, a plurality of MLMs to predict the first outcome variable, each MLM utilizing a different set of input variables of the plurality of different input variables. The instructions further cause the processor device to test, using historical data that identifies historical values for the first outcome variable, each MLM to determine an accuracy for each MLM. The instructions further cause the processor device to identify, for use in making predictions, a first MLM based on the testing.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first format” and “second format,” and does not imply a priority, a type, an importance, or other attribute, unless otherwise stated herein. The term “about” used herein in conjunction with a numeric value means any value that is within a range of ten percent greater than or ten percent less than the numeric value.

As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

The embodiments disclosed here provide detailed predictions for future metrics based on a trained machine-learning model (MLM) and recent metrics. While the embodiments are discussed herein in the context of an automobile dealership and automobile sales and purchases, the embodiments have applicability in any context regarding inventory and transactions of such inventory, including by way of non-limiting example, motorcycles, recreational vehicles, light machines, homes, rental units, consumer packaged good products, and the like.

The embodiments utilize a combination of one or more multiple different datasets of data depending on which datasets are available, generate and train a plurality of different machine-learning models utilizing different algorithms for a particular outcome variable for a particular dealership, with a final MLM that combines predictions from multiple other MLMs to generate the highest accuracy for implementation. The embodiments also provide a data visualizer configured to generate user interface imagery that identifies current metrics as well as predicted metrics that are based on the current metrics and the machine-learning model. The embodiments provide a highly accurate mechanism for predicting a future outcome, such as a monthly sales volume, in-store customer volume, lead volume, or the like.

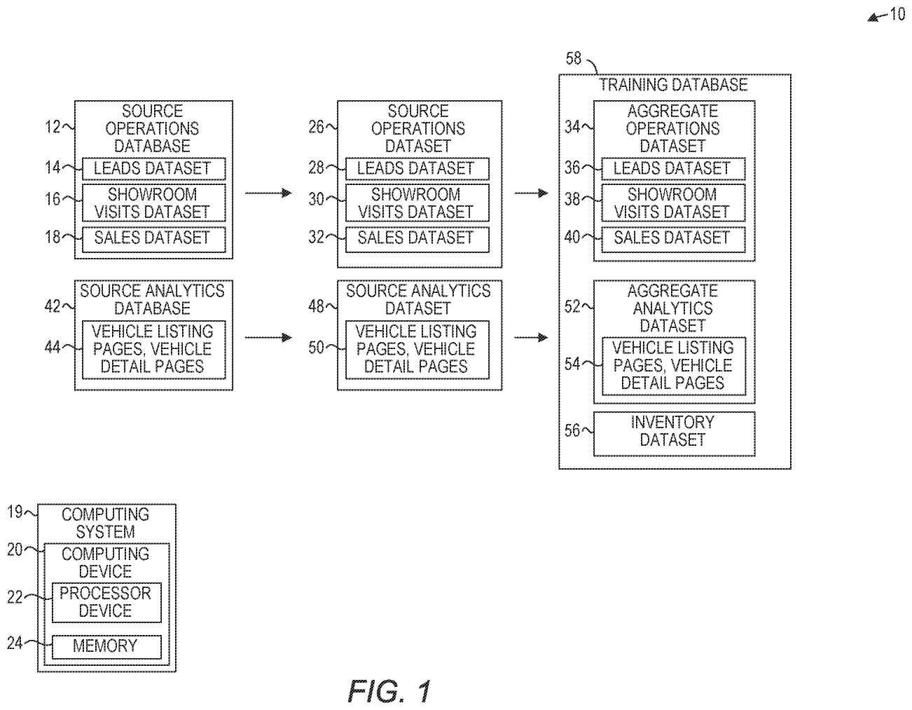

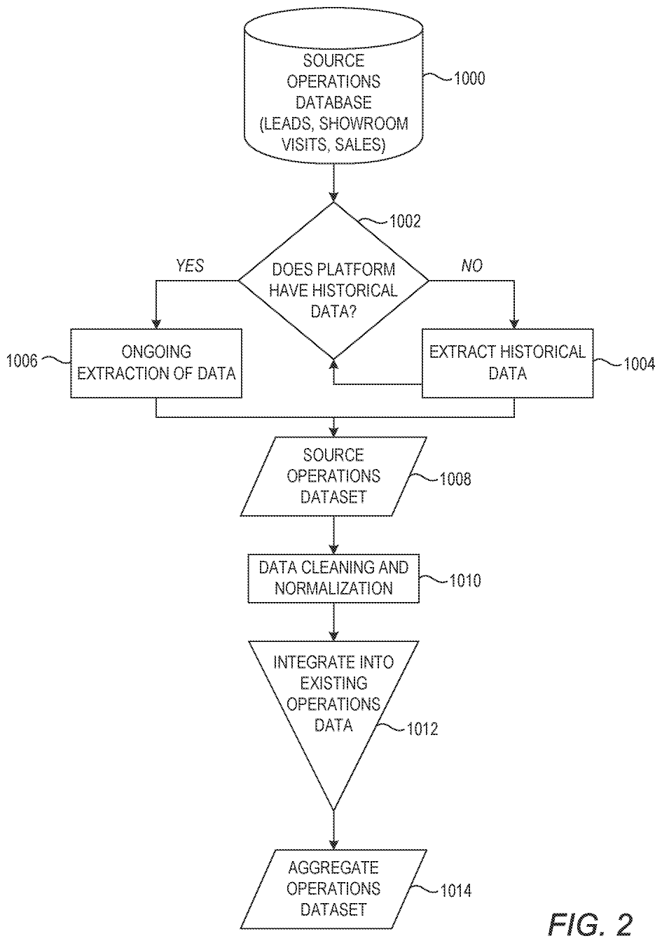

FIG. 1 is a block diagram of an environment 10 illustrating the collection and modification of certain data suitable for training MLMs in accordance with the embodiments disclosed herein. FIG. 2 is a flowchart of a method for generating data suitable for training an MLM. FIGS. 1 and 2 will be discussed in conjunction with one another. Referring first to FIG. 1, an entity, such as a vehicle dealership, such as, by way of non-limiting example, a car dealership, maintains data regarding the operations of the dealership. In this example, the data is referred to generally as a source operations database 12. In practice, the data illustrated as being maintained in the source operations database 12 may be maintained in any number of databases or data structures. The source operations database 12 may include a leads dataset 14 that contains information, such as leads records, regarding customer leads. Each leads record may include, for example, vehicle information (e.g., vehicle type, vehicle year, vehicle make, vehicle model, vehicle trim, a vehicle identification number (VIN), vehicle stock number), lead date, sold date, gross profit, deal number, deal type, associated sales representatives, associated business development center representatives, sale price, dealership name, deal type (e.g., wholesale, purchase, lease, cash), lead type (e.g., internet, walk-in, phone call, parts & service, commercial, referral, previous customer), lead source (e.g., individual advertising source that drove the lead, e.g., the dealer's website, or a billboard), and lead status (e.g., bad, active, sold, complete). Each of these separate elements may be referred to as “variables” or “input variables” in the context of training an MLM, as will be described herein. For example, the lead date for a particular lead is referred to as a lead date (input) variable, and the lead date variable may contain different values for different leads records in the leads dataset 14.

The source operations database 12 may include a showroom visits dataset 16 that contains information, such as showroom visit records, regarding showroom visits by customers. Each showroom visit record may contain the following input variables for use in training an MLM: vehicle information (e.g., vehicle type, vehicle year, vehicle make, vehicle model, vehicle trim, vehicle identification number (VIN), vehicle stock number), vehicle lead type (e.g., internet, walk-in, phone call, parts & service, commercial, referral, previous customer), lead date, sold date, lead source (e.g., individual advertising source that drove the lead, e.g., the dealer's website, or a billboard), lead status (e.g., bad, active, sold, complete), visit activities (e.g., test drive, walk around vehicle, write up deal, taken to finance manager, customer will be back, reason for visit ending), visit date, visit time, sold date, associated sales representatives, associated business development center representatives, sale price, gross profit, dealership name, deal type (e.g., wholesale, purchase, lease, cash), and trade-in information (e.g., year, make, model, trim).

The source operations database 12 may include a sales dataset 18 that contains information, such as sales records, regarding sales of vehicles. Each sales record may contain the following input variables for use in training an MLM: vehicle information (e.g., vehicle type, vehicle year, vehicle make, vehicle model, vehicle trim, vehicle identification number (VIN), vehicle stock number), lead type (e.g., internet, walk-in, phone call, parts & service, commercial, referral, previous customer), lead date, sold date, lead source (e.g., individual advertising source that drove the lead, e.g., the dealer's website, or a billboard), lead status (e.g., bad, active, sold, complete), associated sales representatives, associated business development center representatives, sale price, gross profit, dealership name, deal type (e.g., wholesale, purchase, lease, cash), and trade-in information (e.g., year, make, model, trim).

The environment 10 includes a computing system 19 that comprises one or more computing devices 20, each of which comprises one or more processor devices 22 and a memory 24. While for purposes of illustration only, one computing device 20 is illustrated, in practice, the embodiments may be implemented on different computing devices. Referring now to FIG. 2, the computing system 19 extracts the data described above from the source operations database 12 (FIG. 2, block 1000). The computing system 19 determines whether the computing system 19 (sometimes referred to herein as “the platform” or “Zerosum”) has historical data from the leads dataset 14, the showroom visits dataset 16 and the sales dataset 18 (FIG. 2, block 1002). If not, the computing system 19 may extract raw historical data from the dealer's internal operations platform(s) from no less than one subset of available data related to the transaction process for as far back as data is available (FIG. 2, block 1004). Such data may include leads data as described above, showroom visit (in-store) data as described above, and sales data, as described above. During this process, all available subsets of data from the dealer's platform may be analyzed and qualified against known and standardized subsets of data. This may only be done once, as the historical data will be processed and stored once extracted.

If historical data for the dealer already exists, then, in an on-going process, raw data from the dealer's internal operations platform(s) is extracted from no less than one subset of available data related to the transaction process in a rolling 30-day period to capture all data and adjustments that may occur after each previous extraction (FIG. 2, block 1006). Such data may include leads data as described above, showroom visit (in-store) data as described above, and sales data, as described above. During this process, all available subsets of data from the dealer's platform may be analyzed and qualified against known and standardized subsets of data. This extraction may be repeated at a desired interval, such as, by way of non-limiting example, every 4 hours.

Referring again to FIG. 1, the computing system 19 generates a source operations dataset 26 that includes a leads dataset 28 that corresponds to the leads dataset 14 but as modified and augmented with historical data as described above in a structured format for further processing, manipulation, and cleaning; a showroom visits dataset 30 that corresponds to the showroom visits dataset 16 but as modified and augmented with historical data as described above in a structured format for further processing, manipulation, and cleaning; and a sales dataset 32 that corresponds to the sales dataset 18 but as modified and augmented with historical data as described above in a structured format for further processing, manipulation, and cleaning.

Referring again to FIG. 2, the computing system 19 accesses the source operations dataset 26 and normalizes, cleans, and augments the data with engineered columns to improve data quality and usefulness and to ensure validity. Product data is matched and normalized to a source dataset of all known products, date (timestamps) standardized and augmented to include additional engineered datapoints on each record including: month of year, days before and/or after a holiday, is date a holiday, day of week, day of week in the month, day in year, if day is weekday/weekend, and remaining days in week, month and year. If present, additional datapoints related to the transaction activity are normalized using universally defined datapoints (FIG. 2, blocks 1008, 1010).

The computing system 19 then integrates the source operations dataset 26 with any existing data already cleaned and normalized for the dealership (FIG. 2, block 102). The integrated data is stored in an aggregate operations data set 34 which contains the final results of the source operations database 12 after data extractions and the processes discussed above (FIG. 2, block 1014). The aggregate operations data set 34 includes a leads dataset 36 that corresponds to the leads dataset 28 but is now suitable for use in training an MLM, a showroom visits dataset 38 that corresponds to the showroom visits dataset 30 but is now suitable for use in training an MLM, and a sales dataset 40 that corresponds to the sales dataset 32 but is now suitable for use in training an MLM.

The environment 10 may also include a source analytics database 42. The source analytics database 42 stores information regarding activity occurring on the website of the dealer. The source analytics database 42 may include a vehicle listing pages and vehicle detail pages dataset 44 that collectively maintain the following variables for use in training an MLM: unique views of vehicle search listing pages, unique views of specific vehicle pages, date of unique view(s) to search listing and specific vehicle pages, source of traffic to the site (e.g., Google, Facebook™, Gmail™), medium of traffic to the site (e.g., “social” for social media platform-based traffic), associated campaign of traffic to the site (e.g., “F150 Retargeting” for users that came to the site from a targeted display ad), associated content of traffic to the site (e.g., “blue F150” for users that clicked on a display ad that had a blue F150 in it), search term of traffic to the site (e.g., “F150 Lease” would be the term a user searched to get to the site), and vehicle information (type, make, model, trim, vehicle identification number (VIN)).

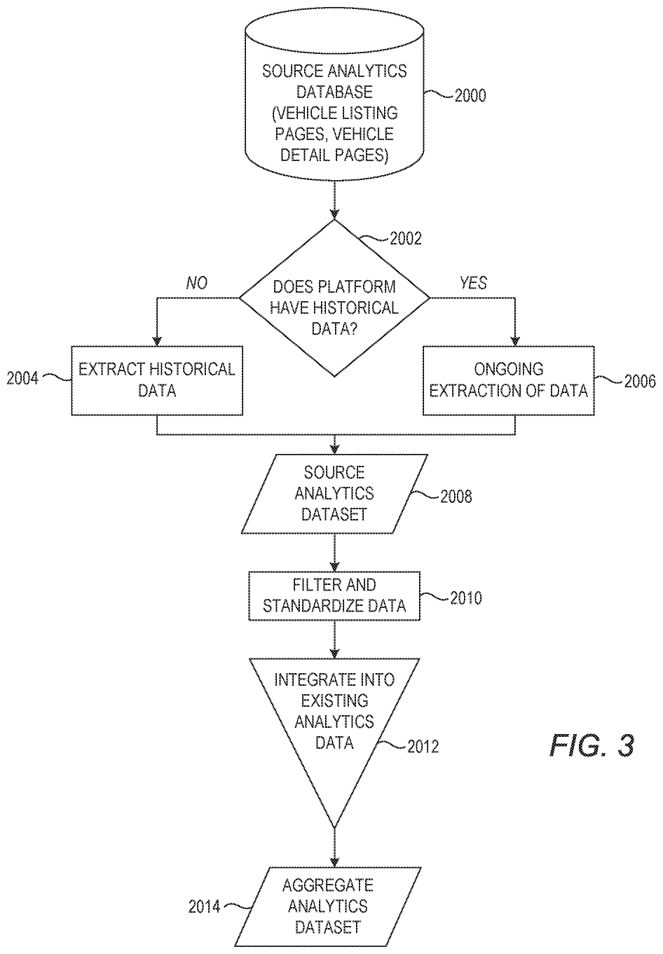

Referring now to FIG. 3, the computing system 19 extracts the data described above from the source analytics database 42 (FIG. 3, block 2000). The computing system 19 determines whether the computing system 19 has historical data from the source analytics database 42 (FIG. 3, block 2002). If not, the computing system 19 may extract raw historical data from the dealer's web analytics platform from no less than one subset of available data related to the transaction process for as far back as data is available (FIG. 3, block 2004). During this process, all available subsets of data from the dealer's platform may be analyzed and qualified against known and standardized subsets of data. This may only be done once, as the historical data will be processed and stored once extracted.

If historical data for the dealer already exists, then, in an on-going process, raw data from the dealer's web analytics platform is extracted from no less than one subset of available data related to the transaction process in a rolling 30-day period to capture all data and adjustments that may occur after each previous extraction (FIG. 3, block 2006). During this process, all available subsets of data from the dealer's platform may be analyzed and qualified against known and standardized subsets of data. This extraction may be repeated at a desired interval, such as, by way of non-limiting example, every 4 hours.

Referring again to FIG. 1, the computing system 19 generates a source analytics dataset 48 that includes a vehicle listing pages and vehicle detail pages dataset 50 that corresponds to the vehicle listing pages and vehicle detail pages dataset 44 but as modified and augmented with historical data as described above in a structured format for further processing, manipulation, and cleaning.

Referring again to FIG. 3, the computing system 19 accesses the source analytics dataset 48 and normalizes, cleans, and augments the data with engineered columns to improve data quality and usefulness and to ensure validity. Product data is matched and normalized to a source dataset of all known products, date (timestamps) standardized and augmented to include additional engineered datapoints on each record including: month of year, days before and/or after a holiday, is date a holiday, day of week, day of week in the month, day in year, if day is weekday/weekend, and remaining days in week, month and year. If present, additional datapoints related to the transaction activity are normalized using universally defined datapoints (FIG. 3, blocks 2008, 2010).

The computing system 19 then integrates the source analytics dataset 48 with any existing data already cleaned and normalized for the dealership (FIG. 3, block 2012). The integrated data is stored in an aggregate analytics dataset 52 that contains the final results of the source analytics database 42 after data extractions and the processes discussed above (FIG. 3, block 2014). The aggregate analytics dataset 52 includes a vehicle listing pages and vehicle detail pages dataset 54 that corresponds to the vehicle listing pages and vehicle detail pages dataset 50 but is now suitable for use in training an MLM.

Note that the processes described above may be repeatedly performed, once or more times each day.

The environment 10 may also include an inventory dataset 56 that is a comprehensive dataset of all inventory in the nation at any given time, currently and historically. The inventory dataset 56 includes inventory information comprising a plurality of vehicle inventory input variables comprising, for each respective vehicle of a plurality of vehicles, one or more of: a year variable that identifies a manufacture year of the respective vehicle, a make variable that identifies a make of the respective vehicle, a model variable that identifies a model of the respective vehicle, trim information that identifies a trim of the respective vehicle, vehicle identification number (VIN) information that identifies a VIN of the respective vehicle, color information that identifies a color of the respective vehicle, transmission information that identifies a transmission of the respective vehicle, a dealership variable that identifies a dealership of the respective vehicle, a condition variable that identifies a new or used condition of the respective vehicle, a drivetrain variable that identifies a drivetrain of the respective vehicle, a fuel type variable that identifies a fuel type of the respective vehicle, a price variable that identifies a price of the respective vehicle, and a lowest advertised price variable that identifies a lowest advertised price of the respective vehicle. The aggregate operations dataset 34, aggregate analytics dataset 52 and inventory dataset 56 collectively may be referred to as product information, which includes the variables discussed above and values for those variables, and collectively compose a training database 58 that may be used to train MLMs, as discussed in greater detail below.

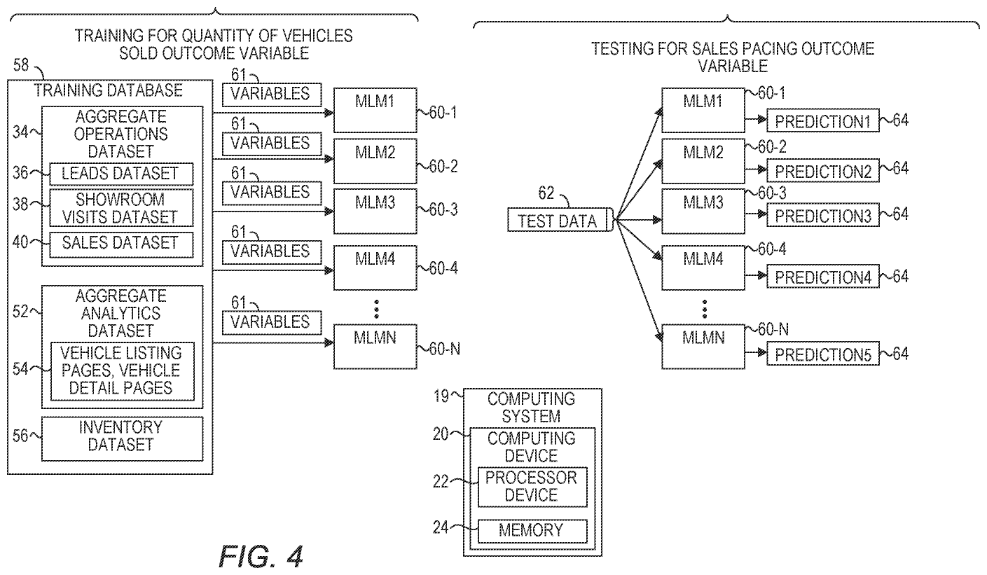

FIG. 4 is a block diagram illustrating a training and selection process for training and selecting an MLM according to one embodiment. Initially, an outcome variable is selected. An outcome variable identifies what is desired to be predicted. The embodiments herein generate MLMs for a plurality of different outcome variables. The outcome variable may comprise any suitable variable related to the sale of an item, including, for example, quantity of vehicles sold, showroom visits, showroom visit goals given other outcome variables, such as quantity of vehicles sold, lead volume, or the like. In this example, the outcome variable is the quantity of vehicles sold. Thus, when trained, it is desired that this particular MLM be able to provide accurate predictions regarding the total quantity of vehicles that will be sold at some future date. In the context of a dealership, the future date may be the last day of the month for example. Thus, on the first day of the month the MLM may make a prediction of the total quantity of vehicles that will be sold by the last day of the month.

In this example, tens or hundreds of MLMs 60-1-60-N may be relatively concurrently trained using different sets 61 of input variables from the training database 58. For example, the MLM 60-1 may be trained with six input variables from the leads dataset 36, four input variables from the showroom visits dataset 38, two input variables from the sales dataset 40, seven input variables from the vehicle listing pages 54, and 11 input variables from the inventory dataset 56. For example, the MLM 60-2 may be trained with 30 input variables from only the inventory dataset 56. Some of the MLMs 60 may be provided all the input variables. It is noted that the embodiments herein can generate a highly accurate MLM with limited training data. For example, if only certain of the data identified in the training database 58 is available, the training process illustrated in FIG. 4 continues irrespective of the quantity of available data. In some embodiments, only the inventory dataset 56 may be available, and a highly accurate MLM 60 may still be generated using the techniques described herein.

Subsequent to training the MLMs 60-1-60-N with different sets of variables, the MLMs 60-1-60-N are tested using historical data such as historical test data 62. The historical test data 62 includes information that identifies historical values for the outcome variable. Accuracy of predictions 64 output by the MLMs 60-1-60-N in response to the test data 62 are determined, and the most accurate MLM 60-1-60-N is selected for use in making predictions for a respective dealership. This generation and testing process may be repeated each day, or multiple times a day, and a separate MLM 60 is generated for each different outcome variable.

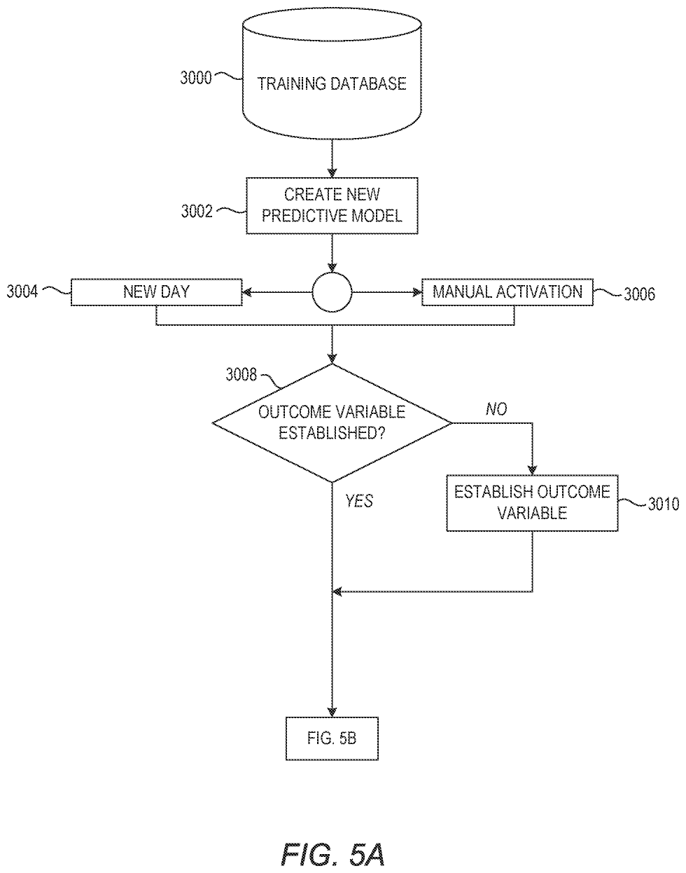

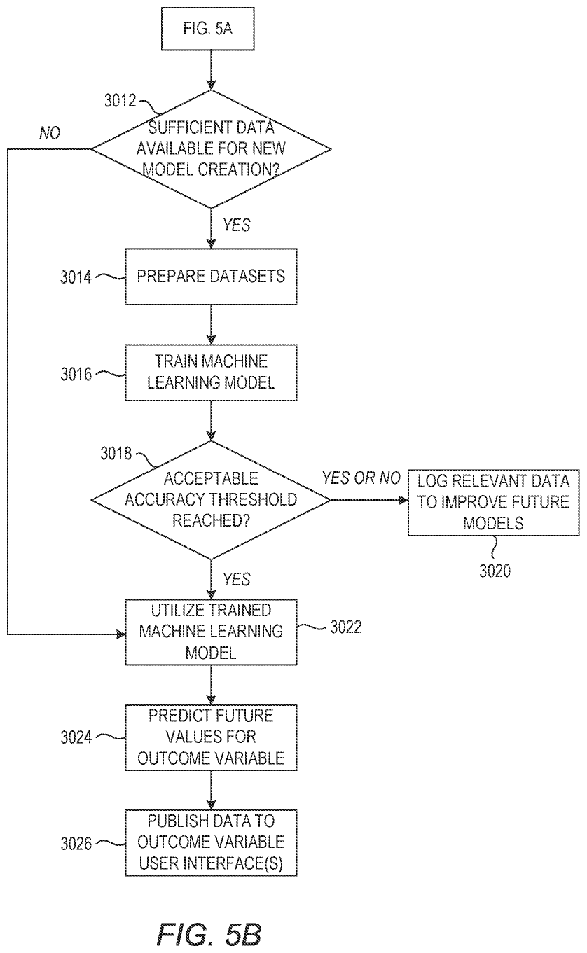

FIGS. 5A-5B illustrate a flowchart of a method for training an MLM according to one embodiment. Referring first to FIG. 5A, the process described herein may be initiated at an arbitrary time or periodically (blocks 3000-3006). The computing system 19 determines if an outcome variable has been established (block 3008). If an outcome variable has not been established, the computing system 19 selects an outcome variable from a predetermined list of outcome variables based on the available datasets in the training database 58 (block 3010). As discussed above, training can occur irrespective of the datasets available in the training database 58. As an example, Table 1 below identifies that irrespective of the training data available, an MLM that predicts the outcome variable of quantity of vehicles sold may still be generated.

TABLE 1

| Data | | | Scenario | Scenario | Scenario | Scenario | Scenario | Scenario | Scenario |
|---|---|---|---|---|---|---|---|---|---|
| Source | Dataset | | 1 | 2 | 3 | 4 | 5 | 6 | 7 |
| First Party | Inventory | Data | Y | Y | N | N | Y | Y | Y |
| Operational | Sales | Available? | Y | Y | Y | Y | Y | N | N |
| | Leads | | Y | Y | N | Y | N | N | N |
| | Showroom | | Y | Y | N | N | N | N | N |
| | Visits | | | | | | | | |
| Analytics | Analytics | | Y | N | N | Y | N | Y | N |

Referring now to FIG. 5B, the computing system 19 checks if sufficient data is available for new model training (block 3012). This may be performed when, for example, an MLM already exists and a determination is made whether sufficient additional data now exists to warrant the generation of a new MLM. If so, the raw data input from the datasets is prepared for new model training (block 3014). The computing system 19 may join and process, through final normalization, missing data cleansing, and column set selection to ensure data completeness, normalcy, quality, and relevance to the outcome variable available datasets related to the outcome variable (block 3014). The computing system 19 splits the finalized datasets and trains the MLMs 60 on N different forecasting models, each model considering N variables in its algorithm to predict the outcome variable (block 3016). Each MLM 60 is scored, and cross-evaluated as well as against a set acceptable accuracy threshold to determine which MLM 60 will be utilized for forecasting.

In some embodiments, each MLM 60 is given no less than 20-25 input variables. The data may be used in part (the split) and wholly to drive the model and reach the best predicted outcome. That same set of data may then be used within multiple models to find the most accurate MLM 60. That data is then used for comparison. All MLMs 60 may initially start with the same training set but may “split” the data to analyze and train on subsets to gain accuracy.

These input variables may include not only the input variables discussed above with regard to the training database 58, but also additional input variables such as, by way of non-limiting example, month-to-date (MTD) sales 30, 60, 90, 365-day moving average, MTD sales through previous day, MTD sales, leads 3, 7, 14-day moving average, showroom visits 3, 7, 14-day moving average, current date, day of month, days in month, week of month, weeks in month, day of week, days remaining in month, days past in month, start day of month, end day of month, and current month.

Each MLM 60 may take a different approach (e.g., may use a different algorithm) to forecast the outcome variable. In some instances, an MLM 60 may use all the available data within each given dataset in a linear regression model to forecast the outcome variable.

In others, while the MLM 60 is given all the variables across available datasets, the MLM 60 may choose to only use some of the variables to forecast the outcome variable. Thus, the MLM 60 may determine that while the MLM 60 received complete operations, inventory, and analytics data, the only subsets of that data the MLM 60 may deem significant to forecasting an outcome variable are the specific datasets of sales, leads, and inventory. This decision-making process is substantial as the cleanliness and conventional mathematical logic is misleading and computationally impossible for a model like linear regression forecasting to account for.

As an example, the leads and showroom visit datasets are typically populated by data predominantly input by employees of a dealership. As such, it is often the case that a sale is recorded without an accompanying data point from one of these pre-sale steps that technically must occur. Every sale technically has a lead associated with it; however, if an employee doesn't record what that lead is, in a vacuum instances can and do arise where 10 sales came from 9 leads.

Some of the MLMs 60 take the decision-making component a step further by looking at the individual attributes of each data point within a dataset, continuously deciding which of those attributes to include or exclude in its forecasting of the outcome variable. The MLM 60 may determine that, while the MLM 60 received complete operations, inventory, and analytics data within the leads dataset, leads with the year, make, model, and lead source attributes have a more significant impact on the outcome variable of sales than do leads with only the make attribute. This approach further accounts for inaccuracies, discrepancies, and mathematical impossibilities that may arise in the datasets.

In some embodiments, each of the MLMs 60 may be run across 50 different iterations (combinations of variables and datasets based on those available), cross-validated, and scored for accuracy against known outcomes of previous outcome variable values, with the most accurate model being chosen for final utilization. In scenarios where only inventory data is available, training and forecasting of the sales volume outcome variable is still possible.

If the computing system 19 determines that an acceptable accuracy threshold is not reached by any MLM 60, data may be logged to improve future model training, and the process of creating a new MLM 60 repeats until the accuracy is at or above the threshold (block 3020). The computing system 19 may otherwise determine that an MLM 60 has a greatest accuracy and select the MLM 60 for use in making predictions (block 3018).

The computing system 19 may then use the selected MLM 60 to predict future values for the outcome variable (blocks 3022, 3024). This may continue until, for example, retraining is manually initiated, it is determined that the MLM 60 no longer meets the desired accuracy threshold, or additional data has been generated that may lead to a more accurate MLM 60. The computing system 19 uses predictions made by the MLM 60 in user interface imagery (block 3026).

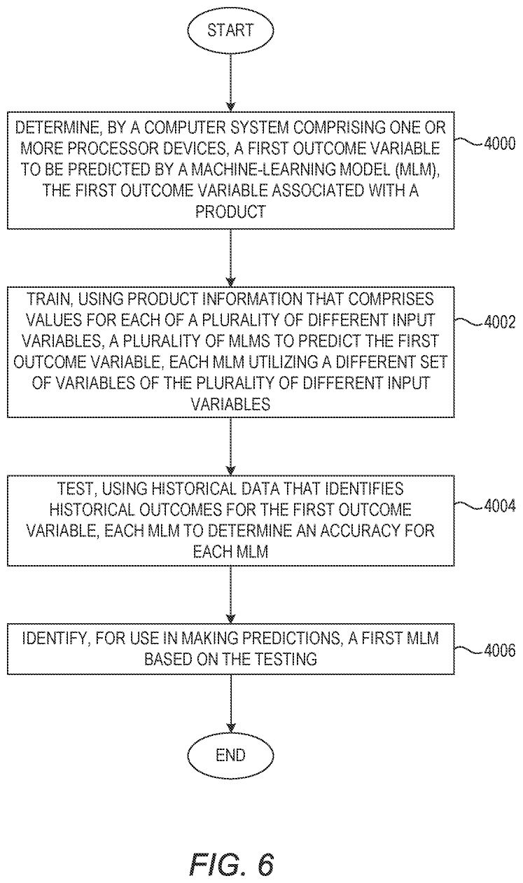

FIG. 6 is a flowchart of a method for training an MLM for predicting metrics associated with transactions according to one embodiment. FIG. 6 will be discussed in conjunction with FIG. 4. The computing system 19 determines an outcome variable to be predicted by an MLM, the outcome variable associated with a product (FIG. 6, block 4000). The computing system 19 trains, using product information that comprises values for each of a plurality of different input variables, the plurality of MLMs 60 to predict the outcome variable, each MLM 60 utilizing a different set 61 of input variables of the plurality of input variables (FIG. 6, block 4002). The computing system 19 tests, using the historical test data 62 that identifies historical outcomes for the outcome variable, each MLM 60 to determine an accuracy for each MLM 60 (FIG. 6, block 4004). The computing system 19 identifies, for use in making predictions, a first MLM 60 based on the testing (FIG. 6, block 4006).

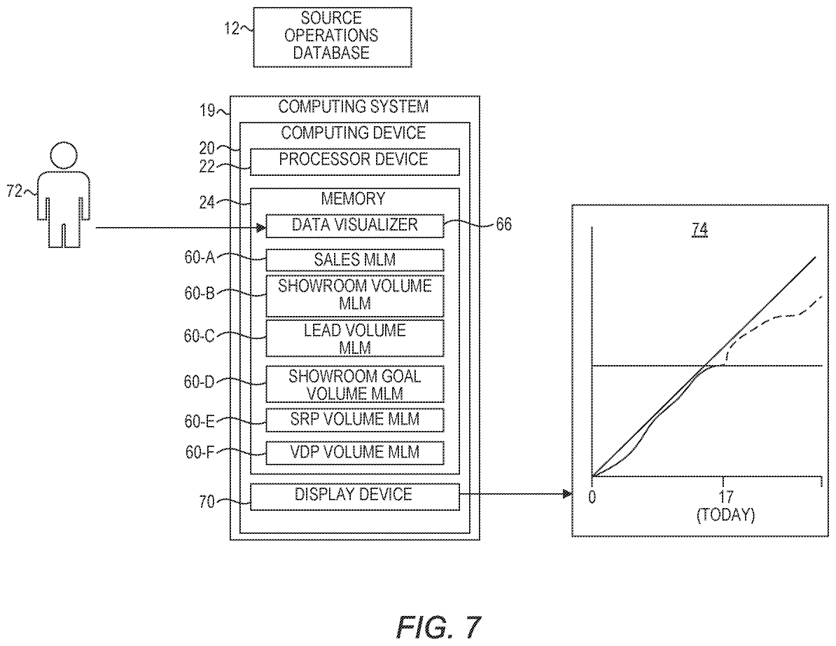

FIG. 7 is a block diagram illustrating a use of the MLMs 60 trained in accordance with the embodiments disclosed herein. In this example, six MLMs 60-A-60-F have been trained and tested based on different outcome variables.

The MLM 60-A has been trained to predict the total quantity of vehicles that will be sold at a future point in time. Thus, the outcome variable for the MLM 60-A is the total quantity of vehicles. The MLM 60-B has been trained to predict the quantity of showroom visits by customers at a future point in time. Thus, the outcome variable for the MLM 60-B is the quantity of showroom visits by customers. The MLM 60-C has been trained to predict the quantity of customer leads at a future point in time. Thus, the outcome variable for the MLM 60-C is the quantity of customer leads. The MLM 60-D has been trained to predict the amount of showroom visits necessary to result in a desired number of vehicles sold. Thus, the outcome variable for the MLM 60-D is the total quantity of showroom visits necessary to meet a designated quantity of vehicles sold. The MLM 60-E has been trained to predict the quantity of search result web pages. A search result web page is a page on the dealer's website that is selected by a user from a list of results presented to the user in response to a search request. For example, a user may enter into a search engine “Subaru WRX”, and be presented with a list of Subaru WRXs on the dealer's website. The page containing the list of Subaru WRXs is a search result web page. Thus, the outcome variable for the MLM 60-E is the quantity of search result web pages. The MLM 60-F has been trained to predict the total quantity of vehicle detail pages. Thus, the outcome variable for the MLM 60-A is the total quantity of vehicle detail pages. A vehicle detail page is a page on a dealer's website for a specific vehicle. As an example, after a user is presented with a search result web page, the user may select a specific Subaru WRX that is listed on the search result web page. The page containing the details for the specific Subaru WRX is the vehicle detail page.

A data visualizer 66 may present user interface imagery on a display device 70 to a user 72. The user 72 may request a prediction from the data visualizer 66. In this example, assume that the user 72 requests a prediction of the total quantity of vehicles that will be sold at the end of the current month. The data visualizer 66 obtains from the source operations database 12, or some other source of information, information that identifies the total quantity of vehicles sold in the current month up to the current date. The data visualizer 66 may input this value into the MLM 60-A. In response, the MLM 60-A predicts the total quantity of vehicles that will be sold at the end of the month. The data visualizer 66 generates user interface imagery 74 that identifies the current sales of vehicles up to the current date, and the predicted total quantity of vehicles sold by the end of the month. The data visualizer 66 presents the user interface imagery 74 on the display device 70. It is noted that, because the data visualizer 66 is a component of the computing system 19, the functionality implemented by the data visualizer 66 may be attributed to the computing system 19 generally. Moreover, where the data visualizer 66 comprises executable software instructions configured to cause the one or more processor devices 22 to implement the described functionality, the functionality implemented by the data visualizer 66 may be attributed to the one or more processor devices 22 generally.

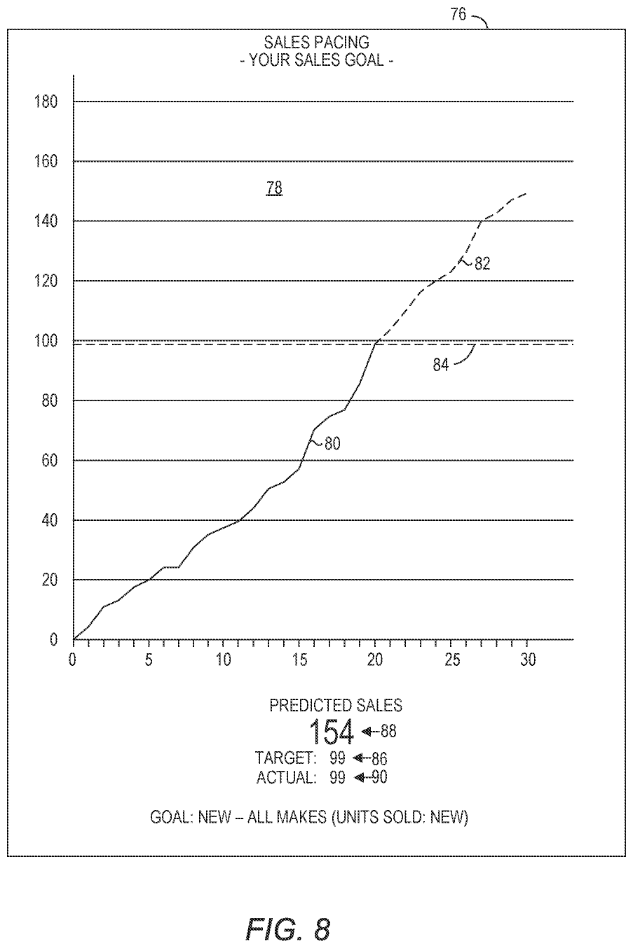

FIG. 8 illustrates example user interface imagery 76 that may be presented to a user according to one embodiment. FIG. 8 will be discussed in conjunction with FIG. 7. In this embodiment, the user 72 has requested a prediction of the total quantity of vehicles sold. The data visualizer 66 obtains from the source operations database 12 the information that identifies the total quantity of vehicles sold in an immediately preceding period of time, in this example, those sold in the current month. The data visualizer 66 inputs this value into the MLM 60-A. In response, the MLM 60-A outputs a plurality of predicted values, each predicted value corresponding to a successive future date in the month, up to the final day of the month. Each predicted value identifies, for the corresponding future date, the predicted total quantity of vehicles that will be sold on that date. It is noted that, in other implementations, the MLM 60-A may output only a single predicted value corresponding to the final date, such as, in this example, the last day of the month. It is further noted that while, solely for purposes of information, time spans of months are discussed herein, the MLMs 60 may predict future values for any future dates or other future points in time and are not limited to future dates in the same month.

The data visualizer 66 generates the user interface imagery 76 that includes a graph 78 having a Y-axis identifying quantities and an X-axis identifying days of the current month. In this example, the current date is the 20th of the month. The data visualizer 66 generates a solid line segment 80 that identifies the actual values of the total quantity of vehicles sold on a daily basis for the preceding period of time by the dealership. The data visualizer 66 generates a dashed line segment 82 that identifies the predicted values obtained from the MLM 60-A for each day of the month in the future until the end of the month. In this example, the MLM 60-A predicts that the dealership will sell 154 vehicles by the last day of the month.

The data visualizer 66 also generates a dashed goal line 84 that identifies the vehicle sales goal of the dealership. The vehicle sales goal may be input by the user 72 or may be established by an initial prediction of monthly sales by the MLM 60-A on the first day of the month. The data visualizer 66 generates a vehicle sales goal value 86, a predicted sales value 88 and a current/actual sales value 90. The vehicle sales goal value 86 corresponds to the value of the dashed goal line 84, in this example, a value of 99. The predicted sales value 88 corresponds to the value of the dashed line segment 82 on the last day of the month, in this example, a value of 154. The current/actual sales value 90 corresponds to the actual quantity of vehicles sold up to the current date, in this example, a value of 99.

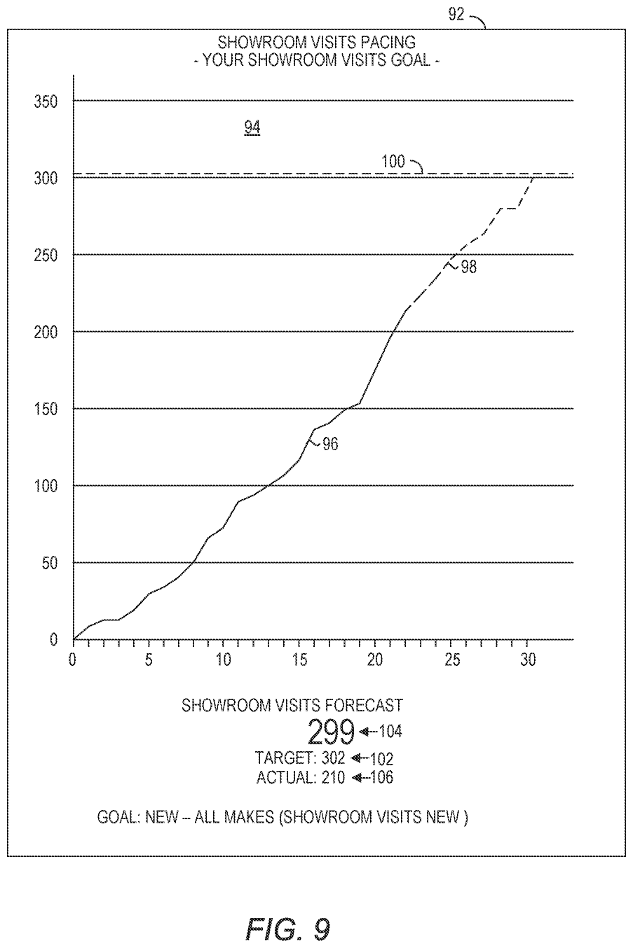

FIG. 9 illustrates example user interface imagery 92 that may be presented to a user according to one embodiment. FIG. 9 will be discussed in conjunction with FIG. 7. In this embodiment, the user 72 has requested a prediction of the total quantity of showroom visits by customers. The data visualizer 66 obtains from the source operations database 12 the information that identifies the total quantity of showroom visits by customers in an immediately preceding period of time, in this example, those in the current month. The data visualizer 66 inputs this value into the MLM 60-B. In response, the MLM 60-B outputs a plurality of predicted values, each predicted value corresponding to a successive future date in the month, up to the final day of the month. Each predicted value identifies, for the corresponding future date, the predicted total quantity of showroom visits by customers on that date. It is noted that, in other implementations, the MLM 60-B may output only a single predicted value corresponding to the final date, such as, in this example, the last day of the month.

The data visualizer 66 generates the user interface imagery 92 that includes a graph 94 having a Y-axis identifying quantities and an X-axis identifying days of the current month. In this example, the current date is the 22th of the month. The data visualizer 66 generates a solid line segment 96 that identifies the actual values of the total showroom visits by customers on a daily basis for the preceding period of time by the dealership. The data visualizer 66 generates a dashed line segment 98 that identifies the predicted values obtained from the MLM 60-B for each day of the month in the future until the end of the month. In this example, the MLM 60-B predicts that the dealership will have 299 showroom visits by customers by the last day of the month.

The data visualizer 66 also inputs, into the MLM 60-D a vehicle sales goal, such as was illustrated in FIG. 8. The MLM 60-D has been trained to predict a number of showroom visits necessary to reach a designated sales goal. The MLM 60-D predicts that 302 showroom visits by customers will be necessary to reach the desired vehicle sales goal. The data visualizer 66 generates a dashed goal line 100 that identifies the showroom visits goal of the dealership. The data visualizer 66 generates a showroom visits goal value 102, a predicted showroom visits value 104 and a current/actual showroom visits value 106.

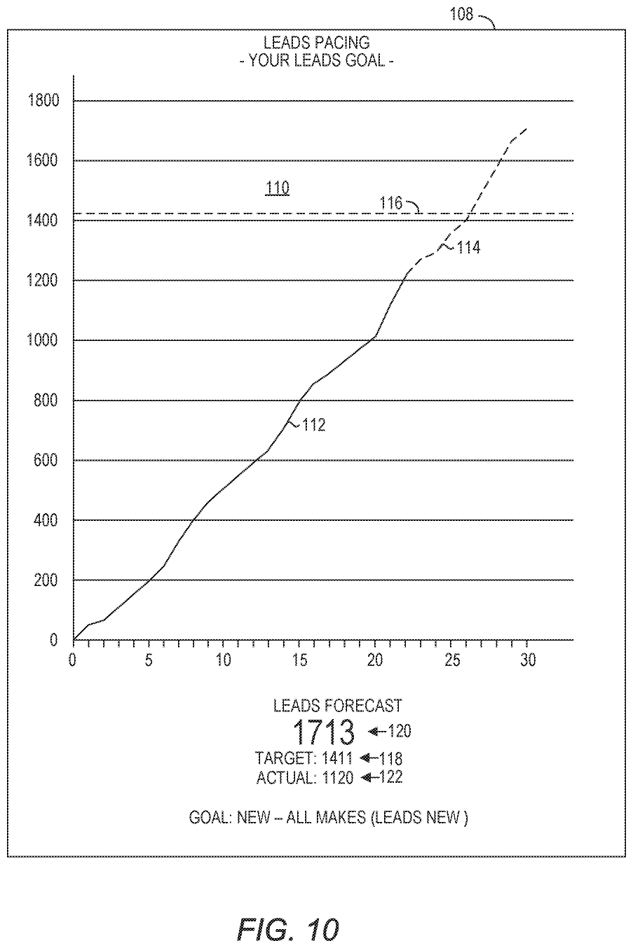

FIG. 10 illustrates example user interface imagery 108 that may be presented to a user according to one embodiment. FIG. 10 will be discussed in conjunction with FIG. 7. In this embodiment, the user 72 has requested a prediction of the total quantity of customer leads. The data visualizer 66 obtains from the source operations database 12 the information that identifies the total quantity of customer leads in an immediately preceding period of time, in this example, those in the current month. The data visualizer 66 inputs this value into the MLM 60-C. In response, the MLM 60-C outputs a plurality of predicted values, each predicted value corresponding to a successive future date in the month, up to the final day of the month. Each predicted value identifies, for the corresponding future date, the predicted total quantity of customer leads on that date. It is noted that, in other implementations, the MLM 60-C may output only a single predicted value corresponding to the final date, such as, in this example, the last day of the month.

The data visualizer 66 generates the user interface imagery 108 that includes a graph 110 having a Y-axis identifying quantities and an X-axis identifying days of the current month. In this example, the current date is the 22th of the month. The data visualizer 66 generates a solid line segment 112 that identifies the actual values of the customer leads on a daily basis for the preceding period of time by the dealership. The data visualizer 66 generates a dashed line segment 114 that identifies the predicted values obtained from the MLM 60-C for each day of the month in the future until the end of the month. In this example, the MLM 60-C predicts that the dealership will have 1713 customer leads by the last day of the month.

The data visualizer 66 generates a dashed goal line 116 that identifies the customer leads goal of the dealership. The data visualizer 66 generates a customer leads goal value 118, a predicted customer leads value 120 and a current/actual customer leads value 122.

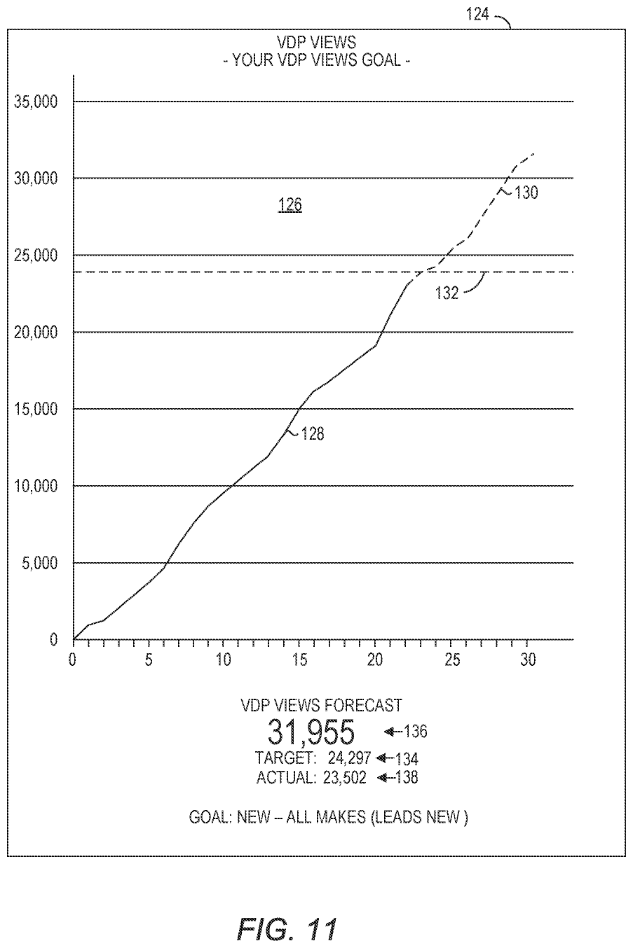

FIG. 11 illustrates example user interface imagery 124 that may be presented to a user according to one embodiment. FIG. 11 will be discussed in conjunction with FIG. 7. In this embodiment, the user 72 has requested a prediction of the total quantity of vehicle detail web pages that will be viewed by individuals accessing the web site of the dealership. The data visualizer 66 obtains from the source operations database 12 the information that identifies the total quantity of vehicle detail web pages that have been viewed by individuals accessing the web site in an immediately preceding period of time, in this example, those in the current month. The data visualizer 66 inputs this value into the MLM 60-F. In response, the MLM 60-F outputs a plurality of predicted values, each predicted value corresponding to a successive future date in the month, up to the final day of the month. Each predicted value identifies, for the corresponding future date, the predicted total quantity of vehicle detail web pages that will be viewed by individuals accessing the web site on that date.

The data visualizer 66 generates the user interface imagery 124 that includes a graph 126 having a Y-axis identifying quantities and an X-axis identifying days of the current month. In this example, the current date is the 22th of the month. The data visualizer 66 generates a solid line segment 128 that identifies the actual values of the total quantity of vehicle detail web pages that have been viewed by individuals accessing the web site of the dealership for the preceding period of time. The data visualizer 66 generates a dashed line segment 130 that identifies the predicted values obtained from the MLM 60-F for each day of the month in the future until the end of the month. In this example, the MLM 60-F predicts that the dealership will have 31,955 vehicle detail web pages viewed by individuals accessing the web site by the last day of the month.

The data visualizer 66 generates a dashed goal line 132 that identifies the vehicle detail pages viewed goal of the dealership. The data visualizer 66 generates a vehicle detail pages viewed goal value 134, a predicted vehicle detail pages viewed value 136 and a current/actual vehicle detail pages viewed value 138.

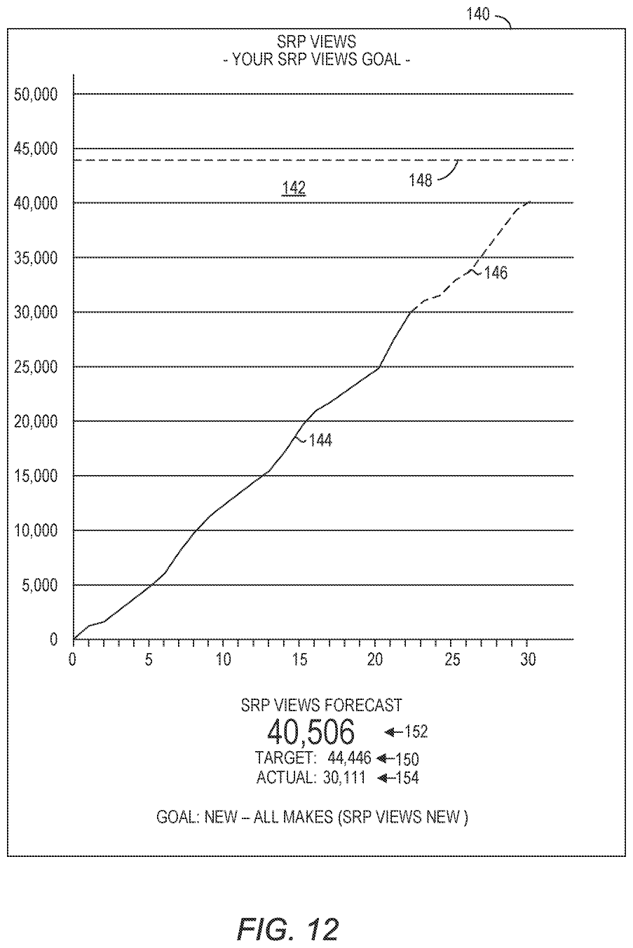

FIG. 12 illustrates example user interface imagery 140 that may be presented to a user according to one embodiment. FIG. 12 will be discussed in conjunction with FIG. 7. In this embodiment, the user 72 has requested a prediction of the total quantity of search result web pages. The data visualizer 66 obtains from the source operations database 12 the information that identifies the total quantity of search result web pages that have been viewed by individuals accessing the web site in an immediately preceding period of time, in this example, those in the current month. The data visualizer 66 inputs this value into the MLM 60-E. In response, the MLM 60-E outputs a plurality of predicted values, each predicted value corresponding to a successive future date in the month, up to the final day of the month. Each predicted value identifies, for the corresponding future date, the predicted total quantity of search result web pages that will be viewed by individuals accessing the web site on that date.

The data visualizer 66 generates the user interface imagery 140 that includes a graph 142 having a Y-axis identifying quantities and an X-axis identifying days of the current month. In this example, the current date is the 22th of the month. The data visualizer 66 generates a solid line segment 144 that identifies the actual values of the total quantity of search result web pages that have been viewed by individuals during the preceding period of time. The data visualizer 66 generates a dashed line segment 146 that identifies the predicted values obtained from the MLM 60-E for each day of the month in the future until the end of the month. In this example, the MLM 60-E predicts that the dealership will have 40,506 search result web pages viewed by individuals accessing the web site by the last day of the month.

The data visualizer 66 generates a dashed goal line 148 that identifies the search result web pages goal of the dealership. The data visualizer 66 generates a search result web pages goal value 150, a predicted search result web pages viewed value 152 and a current/actual search result web pages viewed value 154.

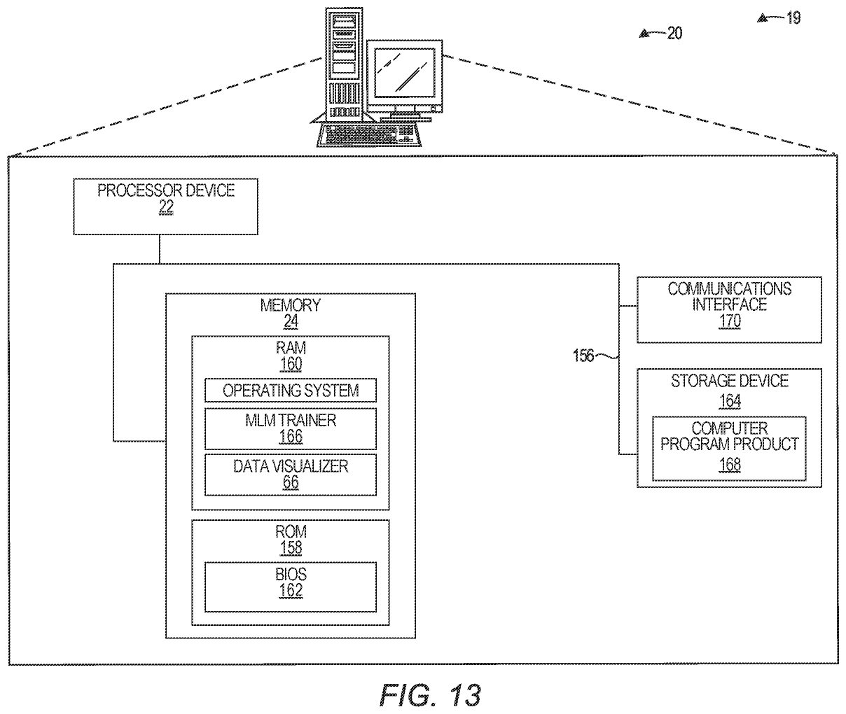

FIG. 13 is a block diagram of the computing system 19 in greater detail according to one embodiment. The computing system 19 includes one or more computing devices 20. Each computing device 20 may comprise any computing or electronic device capable of including firmware, hardware, and/or executing software instructions to implement the functionality described herein, such as a computer server, a desktop computing device, a laptop computing device. The computing device 20 may be utilized to generate one or more machine-learning models in accordance with the processes discussed above, and/or present user interface imagery based on such MLMs.

The computing device 20 includes one or more processor devices 22, the memory 24, and a system bus 156. The system bus 156 provides an interface for system components including, but not limited to, the system memory 24 and the processor device 22. The processor device 22 can be any commercially available or proprietary processor.

The system bus 156 may be any of several types of bus structures that may further interconnect to a memory bus (with or without a memory controller), a peripheral bus, and/or a local bus using any of a variety of commercially available bus architectures. The system memory 24 may include non-volatile memory 158 (e.g., read-only memory (ROM), erasable programmable read-only memory (EPROM), electrically erasable programmable read-only memory (EEPROM), etc.), and volatile memory 160 (e.g., random-access memory (RAM)). A basic input/output system (BIOS) 162 may be stored in the non-volatile memory 158 and can include the basic routines that help to transfer information between elements within the computing device 20. The volatile memory 160 may also include a high-speed RAM, such as static RAM, for caching data.

The computing device 20 may further include or be coupled to a non-transitory computer-readable storage medium such as a storage device 164, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 164 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 164 and in the volatile memory, including an operating system and one or more program modules, such as an MLM trainer 166 that is configured to train MLMs in accordance with the processes described herein, and/or the data visualizer 66. All or a portion of the examples may be implemented as a computer program product 168 stored on a transitory or non-transitory computer-usable or computer-readable storage medium, such as the storage device 164, which includes complex programming instructions, such as complex computer-readable program code, to cause the processor device 22 to carry out the steps described herein. Thus, the computer-readable program code can comprise software instructions for implementing the functionality of the examples described herein when executed on the processor device 22.

The user 72 may also be able to enter one or more commands through a keyboard (not illustrated), a pointing device such as a mouse (not illustrated), or a touch-sensitive surface such as a display device. The computing device 20 may also include a communications interface 170 suitable for communicating with a network as appropriate or desired.

Those skilled in the art will recognize improvements and modifications to the preferred embodiments of the disclosure. All such improvements and modifications are considered within the scope of the concepts disclosed herein and the claims that follow.

What is claimed is:

1. A method comprising:
determining, by a computer system comprising one or more processor devices, a first outcome variable to be predicted by a machine-learning model (MLM), the first outcome variable associated with a product;
training, using product information that comprises values for each of a plurality of different input variables, a plurality of MLMs to predict the first outcome variable, each MLM utilizing a different set of input variables of the plurality of different input variables;
testing, using historical data that identifies historical values for the outcome variable, each MLM to determine an accuracy for each MLM; and
identifying, for use in making predictions, a first MLM based on the testing.

2. The method of claim 1 wherein the first outcome variable comprises a quantity of vehicles sold for a vehicle dealership at a future date, and wherein the product information comprises inventory information comprising a plurality of vehicle inventory variables comprising, for each respective vehicle of a plurality of vehicles, one or more of: a year variable that identifies a manufacture year of the respective vehicle, a make variable that identifies a make of the respective vehicle, a model variable that identifies a model of the respective vehicle, trim information that identifies a trim of the respective vehicle, vehicle identification number (VIN) information that identifies a VIN of the respective vehicle, color information that identifies a color of the respective vehicle, transmission information that identifies a transmission of the respective vehicle, a dealership variable that identifies a dealership of the respective vehicle, a condition variable that identifies a new or used condition of the respective vehicle, a drivetrain variable that identifies a drivetrain of the respective vehicle, a fuel type variable that identifies a fuel type of the respective vehicle, a price variable that identifies a price of the respective vehicle, and a lowest advertised price variable that identifies a lowest advertised price of the respective vehicle.

3. The method of claim 2 wherein the inventory information comprises information about vehicle inventory at a plurality of different dealerships.

4. The method of claim 2 wherein the product information comprises only the inventory information.

5. The method of claim 1 further comprising:
receiving, by the computer system, a request for a prediction of the first outcome variable at a future point in time;
receiving, from the first MLM, a predicted value of the first outcome variable;
generating first user interface imagery that includes information that identifies actual values of the first outcome variable over an immediately preceding period of time and that identifies the predicted value of the first outcome variable at the future point in time; and
presenting the first user interface imagery on a display device.

6. The method of claim 5 further comprising:
prior to receiving, from the first MLM, the predicted value, determining the actual values of the first outcome variable over the immediately preceding period of time; and
inputting the actual values of the first outcome variable over the immediately preceding period of time into the first MLM.

7. The method of claim 5 further comprising:
receiving, from the first MLM, a plurality of predicted values of the first outcome variable, the plurality of predicted values corresponding to a plurality of future points in time between a current point in time and the future point in time, and wherein the user interface imagery identifies the plurality of predicted values and identifies the plurality of future points in time.

8. The method of claim 7 wherein the first outcome variable comprises a quantity of vehicles sold, and wherein the first user interface imagery comprises a graph that identifies the actual values of the quantity of vehicles sold for each day in the immediately preceding period of time and identifies predicted values of the quantity of vehicles sold for each day of a plurality of future days.

9. The method of claim 8 wherein the first user interface imagery further comprises information that identifies a target goal of the quantity of vehicles sold for a month, a predicted quantity of vehicles to be sold for the month and an actual quantity of vehicles sold for the month on a current date.

10. The method of claim 5 wherein the first outcome variable comprises a quantity of vehicles sold, and further comprising:
inputting, by the computer system, the predicted value of the quantity of vehicles sold into a showroom visits goal MLM trained to predict a value for a showroom visits goal outcome variable that identifies a quantity of showroom visits necessary to sell a designated quantity of vehicles;
receiving, from the showroom visits goal MLM, a predicted showroom visits goal value based on the predicted value of the quantity of vehicles sold;
generating second user interface imagery that includes information that identifies the predicted showroom visits goal value; and
presenting the second user interface imagery on the display device.

11. The method of claim 5 further comprising:
receiving, by the computer system, a request for a prediction of a showroom visits outcome variable at the future point in time;
determining actual values that identify showroom visits over the immediately preceding period of time;
inputting the actual values that identify the showroom visits over the immediately preceding period of time into a predicted showroom visits MLM trained to predict a quantity of showroom visits at the future point in time;
receiving, from the predicted showroom visits MLM, a predicted showroom visits value;
generating second user interface imagery that includes information that identifies actual values of the showroom visits over the immediately preceding period of time and that identifies the predicted showroom visits value at the future point in time; and
presenting the second user interface imagery on the display device.

12. The method of claim 1 wherein the product information comprises customer leads information comprising a plurality of customer lead variables comprising, for each respective customer lead of a plurality of customer leads, one or more of: a vehicle information variable that identifies a vehicle associated with the respective customer lead, a customer lead date variable that identifies a date of the customer lead, and a sold date variable that identifies a date the customer corresponding to the customer lead purchased the vehicle.

13. The method of claim 1 wherein the first outcome variable comprises one of a quantity of sales, a quantity of showroom visits, a quantity of leads, and a quantity of web page activity.

14. A computing system comprising:
a memory; and
one or more processor devices coupled to the memory to:
determine a first outcome variable to be predicted by a machine-learning model (MLM), the first outcome variable associated with a product;
train, using product information that comprises values for each of a plurality of different input variables, a plurality of MLMs to predict the first outcome variable, each MLM utilizing a different set of input variables of the plurality of different input variables;
test, using historical data that identifies historical values for the first outcome variable, each MLM to determine an accuracy for each MLM; and
identify, for use in making predictions, a first MLM based on the testing.

15. The computing system of claim 14 wherein the inventory information comprises information about vehicle inventory at a plurality of different dealerships.

16. The computing system of claim 15 wherein the product information comprises only the inventory information.

17. The computing system of claim 14 wherein the one or more processor devices are further to:
receive a request for a prediction of the first outcome variable at a future point in time;
receive, from the first MLM, a predicted value of the first outcome variable;
generate first user interface imagery that includes information that identifies actual values of the first outcome variable over an immediately preceding period of time and that identifies the predicted value of the first outcome variable at the future point in time; and
present the first user interface imagery on a display device.

18. A non-transitory computer-readable storage medium that includes executable instructions to cause a processor device to:
determine a first outcome variable to be predicted by a machine-learning model (MLM), the first outcome variable associated with a product;
train, using product information that comprises values for each of a plurality of different input variables, a plurality of MLMs to predict the first outcome variable, each MLM utilizing a different set of input variables of the plurality of different input variables;
test, using historical data that identifies historical values for the first outcome variable, each MLM to determine an accuracy for each MLM; and
identify, for use in making predictions, a first MLM based on the testing.

19. The non-transitory computer-readable storage medium of claim 18 wherein the inventory information comprises information about vehicle inventory at a plurality of different dealerships.

20. The non-transitory computer-readable storage medium of claim 19 wherein the product information comprises only the inventory information.
